(19) United States
(12) Patent Application Publication
(10) Pub. No.: US 2023/0406549 A1
(43) Pub. Date: Dec. 21, 2023

(54) UAV SYSTEM AND METHOD FOR SIMULATION OF REDUCED-GRAVITY ENVIRONMENTS

(71) Applicant: RAPTOR AEROSPACE LTD, Kettering Northamptonshire (GB)

(72) Inventors: Callum Dominic Cabielles Rolfe, Kettering Northamptonshire (GB); Adam William Oxbury, Kettering Northamptonshire (GB); Aaron McNeil, Kettering Northamptonshire (GB)

(21) Appl. No.: 18/252,494

(22) PCT Filed: Nov. 10, 2021
(86) PCT No.: PCT/GB2021/052911

§ 371 Date: May 10, 2023

(30) Foreign Application Priority Data
Nov. 10, 2020 (GB) 2017735.8

(51) Int. Cl. B64G 7/00; B64U 70/20; B64U 50/14; B64U 50/19; B64U 70/83

(52) U.S. Cl. CPC B64G 7/00; B64U 70/20; B64U 50/14; B64U 50/19; B64U 70/83; B64U 2101/60

(57) ABSTRACT

UAV (400, 500, 600) systems and methods for simulation of reduced-gravity environments are disclosed. A UAV (400, 500, 600) system has an ascent vehicle (104), comprising ascent thrust means, and an aerodynamic, free fall descent UAV (102, 706), comprising descent thrust means. The ascent vehicle (104) comprises means to convey the descent UAV (102, 706) to a drop altitude (108), and the descent UAV (102, 706) is separable from the ascent vehicle (104). The descent thrust means is operable, following separation of the descent UAV (102, 706) from the ascent vehicle (104), to provide a thrust component in a descent direction (256), for countering air resistance on the UAV (400, 500, 600). The descent UAV (102, 706) may comprise a sensor system and controller (204), and the descent thrust means may comprise a ducted fan system. The sensor system may be operable, during descent of the UAV (400, 500, 600), to determine values for parameters associated with the acceleration due to gravity of the UAV (400, 500, 600), the controller (204) being operable to use the determined parameter values to control the ducted fan system to provide the thrust component.

### FIELD OF THE INVENTION

This invention is directed to uncrewed or unmanned aerial vehicles (UAVs), UAV systems and methods for simulation of reduced-gravity environments.

### BACKGROUND OF THE INVENTION

Simulation of reduced-gravity environments is a discipline increasing in importance in applications for orbital, outer space and planetary science, exploration and commercialisation. Micro-gravity conditions (for example, in orbital environments), or lower-than-Earth gravity conditions, such as may be experienced on the Lunar surface or on the surface of planetary bodies, can be simulated by terrestrial devices and systems. The simulated conditions or environment can be used to test components or devices, or to perform experiments in those conditions, without having to use or test within the environment itself, for example without incurring the expense of putting the component or experiment itself in orbit (or transporting it to the Moon or another planet).

One example of such simulation known to the art is use of a drop tower, a vertical tube which has been evacuated so that air resistance on an article dropped within it can be removed or reduced, so that the article will briefly experience micro-gravity during the fall. In another example, an aircraft performing a series of parabolic manoeuvres can provide short periods of reduced or micro-gravity for devices or experiments on board. However, these examples are typically too expensive to be available for widespread use, the testing periods achievable are extremely short, and in some cases the quality of the simulated reduced gravity is not sufficient for certain testing or experiments. UAVs of various types, such as fixed wing, or rotor or propeller driven UAVs are well known to the art. In previously considered systems, a UAV has been proposed to provide reduced gravity environment simulation, for a payload of the UAV. In one example, a UAV is proposed to provide thrust in a descent direction to counter air resistance in freefall, to attempt to approximate micro-gravity conditions. Typically the reduced gravity conditions produced in these previously proposed systems are of insufficient quality and duration. In addition, at the speeds required for simulating micro-gravity, propulsion systems such as rotors or propellers either fail or cannot provide sufficient downward thrust.

Furthermore, it is unclear whether such proposed systems could complete a descent flight and still produce a valid simulation, without endangering the UAV, since the propulsion systems used (or the UAV itself) are heavy, increasing the weight of the UAV and therefore the braking requirement at the end of the simulation period in order to safely recover the UAV. In addition, the bulk of such propulsion systems increases the aerodynamic drag which must be overcome.

Moreover, the propulsion systems used do not provide sufficiently variable or accurate control in order to provide a reasonable quality of reduced gravity environment simulation during the descent. In addition, most such systems are not capable of providing partial (reduced) gravity conditions, such as might be used to simulate Lunar or other planetary body conditions, as the propulsion systems cannot be used to produce these conditions.

The present invention aims to address these problems and provide improvements upon the known devices and methods.

### STATEMENT OF INVENTION

Aspects and embodiments of the invention are set out in the accompanying claims.

In general terms, one embodiment of a first aspect of the invention can provide a UAV system for simulation of reduced-gravity environments, comprising: an ascent UAV, comprising ascent thrust means; and an aerodynamic, free fall descent UAV, comprising descent thrust means, wherein the ascent UAV comprises means to convey the descent UAV to a drop altitude, and wherein the descent UAV is separable from the ascent UAV, the descent thrust means operable, following separation of the descent UAV from the ascent UAV, to provide a thrust component in a descent direction, for countering air resistance on the UAV.

Providing a separate descent UAV in a UAV system for reduced-gravity simulation allows the descent UAV to be designed for descent power specifically (rather than for both ascent and descent power, as in previously considered systems). Since counter-acting the air resistance on the UAV requires less thrust than ascending such a UAV system, the descent thrust means can be smaller, less powerful, or a different thrust technology all together from previously considered systems, thus reducing weight, bulk and complexity for the descent phase. The reduced weight in turn means that braking and recovery of the UAV is sufficiently manageable that safe descent after a valid simulation is viable. Since the descent thrust means can also be less bulky, this reduces the aerodynamic drag acting on the vehicle, reducing the thrust required to counter-act the air resistance. Furthermore, since the simulation provided can be valid and of sufficient quality for certain tests and experiments, the cost and complexity in comparison to drop tower and parabolic flight systems can be heavily reduced.

The drop altitude may be a drop, release, deployment or launch height, or location. The ascent UAV may be any suitable ascent UAV such as those known to the art, such as rotor or fixed wing UAVs, operable to be coupled to the descent UAV during ascent so as to convey, carry, lift or transport it to the drop altitude, and operable to release, drop or deploy it at that altitude. The ascent thrust means may be a thrust device or plurality of devices such as rotors or propellers, or other suitable drivers, motors or engines. The reduced, decreased, diminished or artificially-lowered gravity environment may be any in which the acceleration due to gravity is lower than on Earth, such as micro-gravity (simulating an orbital environment) or for example a Lunar or Mars gravity environment.

Optionally, the descent thrust means is operable to provide variable thrust. Suitably, the descent thrust means comprises a plurality of component thrust means. In embodiments, the descent thrust means comprises a ducted fan system. Optionally, the ducted fan system comprises a plurality of electric ducted fans.

Suitably, the descent UAV comprises: a sensor system; and a controller, the sensor system operable, during descent of the UAV, to determine values for parameters associated with the acceleration due to gravity of the UAV, and the controller operable to use the determined parameter values to control the descent thrust means.

Optionally, the descent UAV comprises a descent thrust mitigation means, operable (during operation of the descent thrust means) to counteract the descent thrust means. This allows maintaining of a desired acceleration level for the descent vehicle, during the simulation phase (in contrast to previously considered systems using braking or parachutes only for a landing phase), for example one that is not the same as acceleration due to gravity on Earth. Other acceleration amounts can be obtained, such as those associated with Lunar or Martian gravity.

In embodiments, the descent thrust mitigation means comprises a secondary thrust means, operable to provide a (variable) thrust component in a direction opposing the descent direction. This may comprise, for example, an additional thrust means, having the same or similar components as the primary thrust means, but facing in a direction opposing the primary thrust means. This allows the mitigation of the primary thrust. In another embodiment, the thrust mitigation means comprises a thruster disposed at a leading section of the descent vehicle.

Alternatively, the descent thrust mitigation means comprises a variable drag inducement means. Optionally, the variable drag inducement means is a modular component removable from the descent UAV. Suitably, the variable drag inducement means comprises at least one auto-rotating rotor. In embodiments, the variable drag inducement means comprises at least one movable drag surface.

Suitably, the descent UAV comprises a housing, which housing enclosing a payload volume. In embodiments, the housing is shaped aerodynamically to reduce drag during descent of the descent UAV. The housing may also be streamlined, or shaped with a teardrop or pointed head.

Optionally, the descent UAV comprises at least one deployable passive deceleration means. The descent UAV may comprise at least two deployable deceleration means, of different types, specifications or having different deceleration modes. This allows peak deceleration to be reduced, preventing excessive deceleration loads on payloads within the descent UAV.

In embodiments, the at least one deployable passive deceleration means comprises at least one parachute. Suitably, the at least one deployable passive deceleration means comprises at least one deployable air brake device.

Suitably, the at least one deployable passive deceleration means comprises a first deployable passive deceleration means, and a second deployable passive deceleration means, wherein the second deployable passive deceleration means is operable after deploying the first deployable passive deceleration means. The second deployable passive deceleration means may be deployed after a threshold deceleration has been achieved. In an embodiment, a sensor measures deceleration and provides a deceleration parameter to a controller to determine whether deceleration has exceeded the threshold for deployment of the second deceleration means. Two-stage deceleration in this manner can reduce deceleration loads on payloads.

In embodiments, the ascent UAV comprises a central annular region, and the means to convey comprises means for securing, accommodating or maintaining the descent UAV within a bore of the ascent UAV annular region. The means to convey may comprise a clasp means for securing the descent UAV, and for allowing separation of the UAVs. The clasp means may be electromagnetic. This arrangement provides that the centre of mass position of the ascent vehicle does not change when the test module is deployed, which allows the system to be better controlled as it can use the same control parameters before and after deployment. It also provides that the aerodynamic stability of the vehicle as a combined system is improved, since the descent UAV does not have to be underslung.

In general terms, one embodiment of another aspect of the invention can provide a system for simulation of reduced-gravity environments, comprising: an ascent vehicle, comprising ascent thrust means; and a descent vehicle, comprising descent thrust means, wherein the ascent vehicle comprises means to convey the descent vehicle, and wherein the descent vehicle is separable from the ascent vehicle, the descent thrust means operable to provide a thrust component in a descent direction.

In general terms, one embodiment of another aspect of the invention can provide a method for simulation of reduced-gravity environments, comprising: ascending an ascent vehicle using ascent thrust means; conveying a descent vehicle during the ascent; separating the descent vehicle from the ascent vehicle; and, during descent, using a descent thrust means of the descent vehicle to provide a thrust component in a descent direction.

In general terms, one embodiment of another aspect of the invention can provide a system for simulation of reduced-gravity environments, comprising: an ascent vehicle, comprising ascent thrust means; and a descent vehicle, comprising descent mitigation means, wherein the ascent vehicle comprises means to convey the descent vehicle, and wherein the descent vehicle is separable from the ascent vehicle, the descent mitigation means operable to provide a descent mitigation component in a descent direction. The descent mitigation means may comprise a variable drag inducement means.

One embodiment of another aspect of the invention can provide a UAV system for simulation of reduced-gravity environments, comprising: a sensor system; a controller; and a ducted fan system, the sensor system operable, during descent of the UAV, to determine values for parameters associated with the acceleration due to gravity of the UAV, the controller operable to use the determined parameter values to control the ducted fan system, and the ducted fan system operable, during descent of the UAV, to provide a thrust component in a descent direction, for countering air resistance on the UAV.

Use of a ducted fan system allows the control of the descent thrust to be sufficiently accurate to allow the provision of a valid and sufficiently high quality of reduced-gravity simulation. In addition, a ducted fan system is operable at the speeds associated with simulating reduced gravity in descent vehicles, in contrast with the propulsion devices used in previously considered systems. Moreover, ducted fans can produce similar thrust to rotor or propeller devices but at a smaller fan/rotor diameter, thereby reducing drag on the vehicle.

The associated parameters may be speed, acceleration, orientation, distance, time and the like. The determining of values for these parameters allows the system to determine an acceleration or acceleration component of the vehicle, and hence how much thrust is required from the thrust means or ducted fan system. Since the values may vary, the determined and applied thrust can also be varied.

Suitably, the system comprises an ascent vehicle comprising ascent thrust means. Optionally, the ascent vehicle is operable to convey the UAV to a drop altitude, and the UAV is separable from the ascent vehicle. This ascent vehicle may not be a UAV, but may be any kind of vehicle capable of conveying the (descent) UAV to the drop altitude.

One embodiment of another aspect of the invention can provide a vehicle system for simulation of reduced-gravity environments, comprising: a sensor system; a controller; and a ducted fan system, the sensor system operable, during descent of the vehicle, to determine values for parameters associated with the vehicle or with the descent, the controller operable to use the determined parameter values to control the ducted fan system, and the ducted fan system operable, during descent of the vehicle, to provide a thrust component in a descent direction.

One embodiment of another aspect of the invention can provide a vehicle system for simulation of reduced-gravity environments, comprising: a sensor system; a controller; and a descent mitigation means, the sensor system operable, during descent of the vehicle, to determine values for parameters associated with the vehicle or with the descent, the controller operable to use the determined parameter values to control the descent mitigation means, and the descent mitigation means operable, during descent of the vehicle, to provide a descent mitigation component in a descent direction. The descent mitigation means may comprise a variable drag inducement means.

One embodiment of another aspect of the invention can provide a method for simulation of reduced-gravity environments, comprising: in a system having a sensor system; a controller; and a ducted fan system, determining, during descent of the vehicle, values for parameters associated with the vehicle or with the descent; using the determined parameter values to control the ducted fan system; and providing, during descent of the vehicle, a thrust component in a descent direction.

One embodiment of another aspect of the invention can provide a method for simulation of reduced-gravity environments, comprising: using an ascent UAV to convey an aerodynamic, free fall descent UAV to a drop altitude; separating the descent UAV from the ascent UAV; and following separation of the descent UAV from the ascent UAV, using a descent thrust means of the descent UAV to provide a thrust component in a descent direction, for countering air resistance on the UAV, such as air resistance during free fall.

The above aspects and embodiments may be combined to provide further aspects and embodiments of the invention.

### BRIEF DESCRIPTION OF THE DRAWINGS

The invention will now be described by way of example with reference to the accompanying drawings, in which:

FIG. 1 is a schematic diagram illustrating a UAV system for simulation of reduced-gravity environments, according to an embodiment of the invention;

FIG. 2a is a diagram illustrating components of a UAV system, according to an embodiment of the invention;

FIG. 2b is a diagram illustrating steps of a method according to an embodiments of the invention:

FIGS. 3a, 3b and 3c are diagrams illustrating a descent UAV for simulation of reduced-gravity environments, and sections thereof, according to embodiments of the invention;

FIG. 4 is a diagram illustrating a descent UAV for simulation of reduced-gravity environments, having a descent thrust mitigation means, according to an embodiment of the invention;

FIGS. 5a and 5b are diagrams illustrating a descent UAV for simulation of reduced-gravity environments, having another descent thrust mitigation means, according to an embodiment of the invention;

FIG. 6 is a diagram illustrating a descent UAV for simulation of reduced-gravity environments, having another descent thrust mitigation means, according to an embodiment of the invention; and

FIGS. 7a to 7c are diagrams illustrating components of a UAV system, according to an embodiment of the invention.

### DETAILED DESCRIPTION OF EMBODIMENTS

Embodiments of the invention provide systems, devices and methods allowing improved and more efficient simulation of reduced-gravity, using innovative arrangements of UAVs and thrust means, and systems having separate ascent and descent vehicles. Embodiments of the invention provide an improved form of rotary UAV system that uses a powered free fall or drop vehicle or descent vehicle or ‘drop pod’ rather than a single UAV, which in previously considered systems provides both the ascent and descent capability, typically using rotors or propellers as the drive, thrust or propulsion system.

In these embodiments, the UAV at a pre-determined altitude falls vertically downwards, and uses a thrust element or propulsion device, such as electric ducted fans (EDFs) to produce sufficient thrust to counteract the effects of air resistance in free fall (at terminal velocity), and in doing so create a simulated reduced or microgravity environment, which exceeds the capabilities of both parabolic aircraft flights and drop-towers in the quality and length of microgravity achieved.

These embodiments thus separate the upward segment of the flight from the fall. The descent UAV or drop pod can also be lifted to altitude by any suitable ascent system including manned aircraft, weather balloons, rockets or UAVs. In embodiments, a large, off-the-shelf multi-rotor UAV is used as a safe and low-cost option.

The descent vehicle is in embodiments an aerodynamic pod that (only) uses its propulsion system to power it downwards and counter air-resistance. Thus the propulsion system on the descent vehicle only needs to be sufficiently powerful to overcome air resistance, rather than to power ascent, and can therefore be simpler, smaller, lighter and of different propulsion type to normal ascent thrust systems. This is in contrast to previously considered systems in which reduced-gravity simulation may have been attempted, but potentially thwarted by the vehicle having too much aerodynamic resistance or drag, therefore requiring a large amount of thrust to counter-act the drag to provide reduced gravity simulation, in turn requiring a large or heavy propulsion system making the system either too heavy to achieve the desired effect, or too prone to failure because of the excessive loads required.

In embodiments, this propulsion system can also be used for attitude control, roll control and elimination of off-axis acceleration during the descent phase, however, these features are similarly implementable using a system which is simpler/different from previously considered systems, and merely sufficiently powerful for this and/or overcoming air resistance.

These systems can produce a physical simulation of microgravity to an acceptable quality, for lengths of time exceeding those of existing systems, while carrying payloads of useful size, for a fraction of the cost of previously considered systems. In addition, embodiments of the invention use additional drag elements or secondary counter-thrust devices to allow efficient simulation of partial gravity during descent, rather than using a propulsion system alone as in previously considered systems. This allows for a more accurate simulation of partial gravity conditions, such as Lunar or Martian gravity.

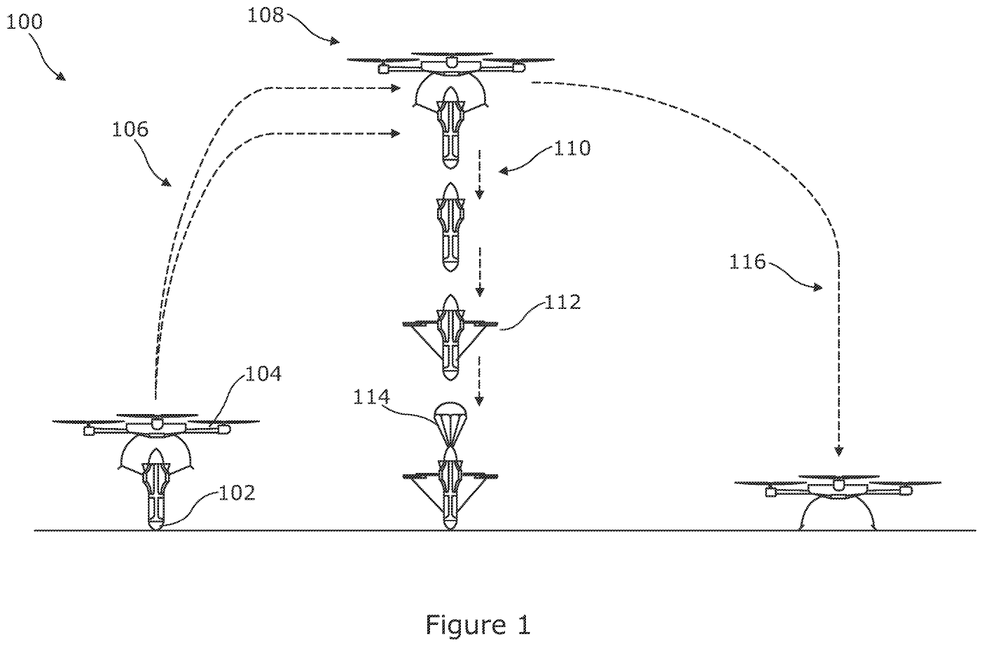

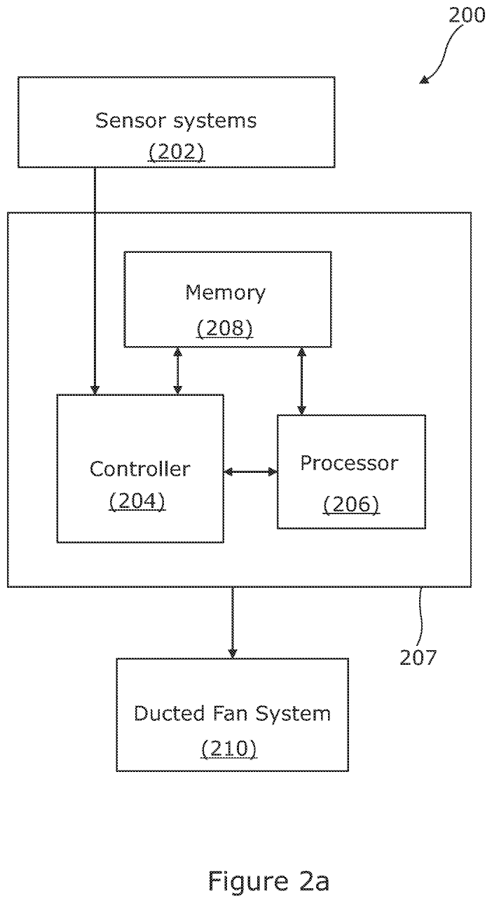

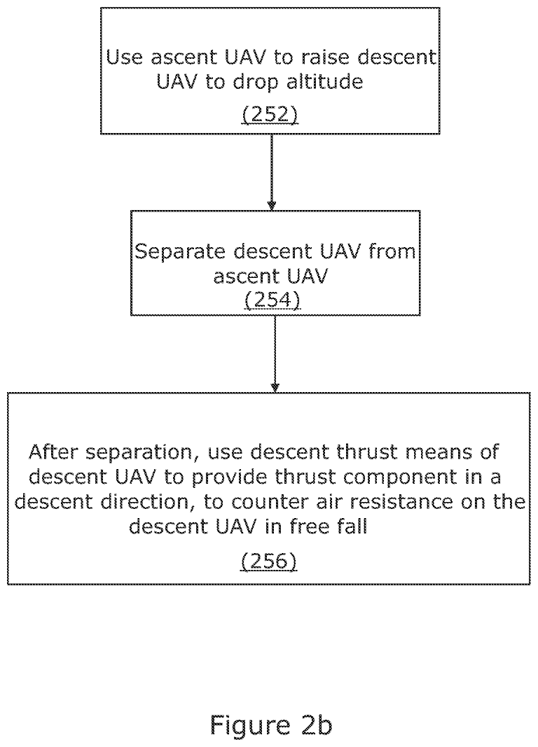

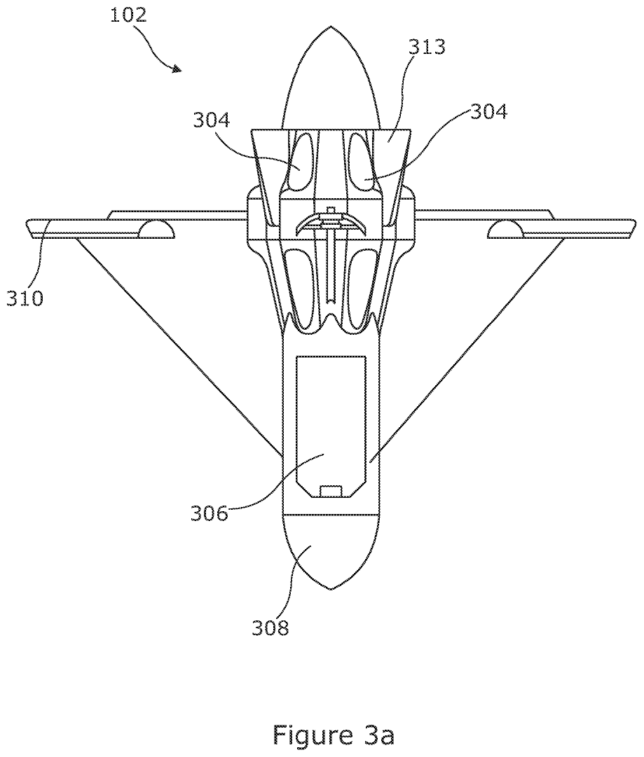

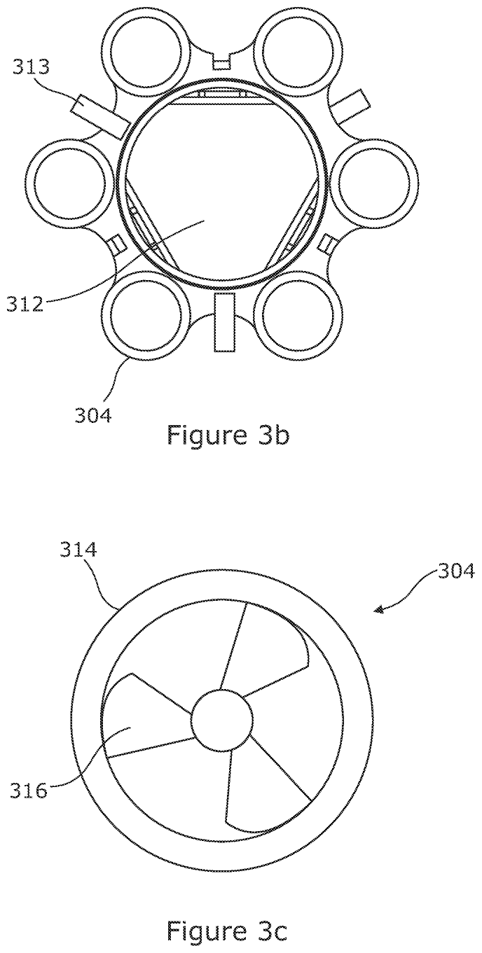

FIGS. 1, 2a and 2b are diagrams illustrating a UAV system 100 and sequencing steps, and components thereof, according to embodiments of the invention. The ascent vehicle 104 comprises an ascent thrust means, such as the rotors illustrated. The descent vehicle or descent UAV 102 has its own thrust means, such as a set of ducted fans (see FIG. 3). The descent UAV is conveyed 106/252 by the ascent vehicle to a pre-determined drop altitude 108 whereupon the two systems separate 110/254, thereby dropping the descent vehicle. The ascent vehicle in the meantime completes a powered vertical landing 116 at a pre-determined landing zone, while the descent vehicle (in which a payload is situated) initiates the reduced or microgravity simulation phase, thereby subjecting the payload to the simulated reduced or microgravity. In one example, the system provides around five seconds of microgravity, at a minimum g-quality of E-3.

During the simulation phase, the descent thrust means (see FIG. 3) provides a thrust component in a descent direction 256, in this case vertically downwards to counter-act air resistance acting vertically upwards on the descent vehicle. The descent thrust means can provide variable thrust, and is controllable to vary the thrust, so that the correct descent acceleration to provide the simulation can be approached and maintained, and so that variations in the descent environment (such as varying air resistance) can be accounted for. The thrust means may be made up of a single thrust device, or a plurality of such devices. In this case, a number of electric ducted fans (EDFs) are used in a ducted fan system 212.

After the simulation phase, the descent vehicle deploys passive deceleration means, such as the air brake system 112 to reduce its terminal velocity to a speed at which the parachute 114 can be deployed. Once the vehicle has fallen to the correct altitude, the parachute module is deployed, and the vehicle decelerates to tolerable impact speeds for landing. During deceleration the propulsive system can provide roll and translational control forces to limit the impact of downrange drift from aerodynamic perturbations in deviating the vehicle from the pre-programmed landing site. Finally, the landed descent vehicle can be collected, inspected for maintenance and recalibrated for the next flight.

As shown in FIG. 2a, the UAV system comprises sensor systems 202, and a controller 204. The sensor systems provide data associated with the descent, such as speed, acceleration and the like, for the controller to use to control the thrust means, for instance to determine how much thrust should currently be applied to overcome air resistance (if, for example, the descent vehicle is not currently accelerating fast enough for the required reduced gravity conditions to be met). The subsystem 207 comprises a processor or processing environment 206, and a memory 208 in order to assist the controller. For example, the memory may store software instructions for the controller to implement in processing the data from the sensor systems. The output of the controller and/or the subsystem 207 is sent to the ducted fan system 210. Generally speaking the control systems in embodiments are autonomous; for example, the processor may control all functions of the system without direct control from a user or from a ground control system. The UAV can therefore operate for example beyond visual line of sight,

In embodiment, EDFs are chosen for the thrust or propulsion means, because of their capability for fine-control for the downward acceleration, having fast response times. Variations in conditions during descent, which may include relatively large impulses on the descent vehicle, can thus be accommodated by the fast reactions allowed by the EDFs, maintaining the required reduced-gravity conditions. Controller software can react to micro-accelerations experienced by the vehicle during the descent phase to control the EDFs.

In addition, ducted fans can operate efficiently to a greater maximum speed than other comparable thrust devices, due to the reduced wave drag at fin or blade tips of the fan. EDFs are also more spatially efficient, so a greater payload bay diameter can be accommodated for a given ascent vehicle payload fairing limit. Furthermore, the lower cross dimensional area of an EDF of the same thrust capability as an equivalent propeller also reduces the profile drag of the pod, reducing the extra thrust required to maintain microgravity conditions in the payload bay. EDFs can also easily be integrated into a housing in a modular arrangement. They also have a predictable flow direction from the back, which also makes thrust vectoring more feasible. In embodiments, the thrust means of the descent vehicle (e.g. EDFs) may be used for roll control and/or thrust vectoring for the vehicle, allowing directional control either during the deceleration phase following simulation, or in some embodiments during the simulation phase if required.

Using a rotor as in previously considered systems could be more propulsively efficient; however, since the descent vehicle's propulsion is used only (or principally) for increasing descent speed/acceleration (and is not, for example, required to ascend the vehicle), this results in a low total thrust requirement. This and the short flight time of the pod mean that comparatively slightly less efficient thrust is less important than all of the above advantages. Indeed, in embodiments of the invention, the thrust means of the descent vehicle is specifically chosen as a system which would otherwise not be capable of providing flight or ascent capability for the vehicle; in other words, the descent vehicle may not be a lift-powered or lift-enabled flight vehicle. The descent vehicle thrust means' purpose in these cases comprises providing a means to counter air resistance (only), to provide simulated reduced gravity. This means that the thrust to weight ratio on the descent vehicle can be chosen (only) for this purpose, and not to (also) allow flight or manoeuvring as in previously considered systems. Thus the descent thrust means can be optimised instead for example for fine thrust control and performance at higher velocities, EDFs are a suitable choice for this purpose.

Landing of the pod is achieved autonomously through a combination of two deceleration means, for example airbrakes and a parachute. Two stage deceleration in this manner means that the maximum peak deceleration can be reduced, but the system nevertheless remains simple and easily manufacturable. Lower peak deceleration is important for certain more fragile experiments and payloads, and is an advantage in comparison to other simulation paradigms, such as drop towers.

Airbrakes are used to make sure that the maximum theoretical terminal velocity of the pod itself will be within the tolerable range for parachute deployment. This could also be achieved with a secondary drogue parachute, but using an airbrake offers the advantages of being more controllable and resettable (post-mission), especially at higher deployment altitudes or in strong wind conditions.

The sensor systems 202 may include one or more altimeters, GPS units, gyroscopes and accelerometers to facilitate the variation of the EDF thrust and thrust distribution, the displacement of the roll control surfaces (see further description below), and the deployment of the airbrake and parachute in the landing phase. For example, the system uses data from an altimeter to trigger the airbrake and parachute deployment at the pre-programmed altitudes in the post test deceleration and landing phase. GPS data is used to vary the EDF thrust levels for directing the vehicle to the landing site in a controlled manner during the post-test phase of the mission. Data from a gyroscope is used to calculate the roll of the vehicle to monitor and respond to roll perturbations by eliciting an anti-roll manoeuvre via the roll control surfaces (see below). A vertically mounted accelerometer is used to record the acceleration level over time in the test phase, and the on-board processing and/or control system use this data in a closed loop control system. For example, the controller 204 and subsystem 207 can employ an axial acceleration model to (accurately) vary the total applied thrust and/or thrust distribution, such that microgravity is maintained to meet the target g-quality for the target g-time. The accelerometer(s) can also be used to measure tangential acceleration, should this be required for maintaining the required conditions.

In an embodiment, the EDF management is controlled by connecting the EDF array to a hybrid power system, which uses discharge circuit hardware that enables voltage output to each engine to be varied and overall and modular thrust output to be controlled. Data collected from the (axially mounted) vertical accelerometer provides the feedback information necessary to complete the acceleration control loop. The discharge circuit also uses intake data from the gyroscope, factors this information into the EDF power allocation and so provides a degree of attitude control.

For roll control, one or more variable-pitch aerodynamic surfaces are positioned directly behind opposite EDF modules. Actuation of these is achieved through a small internal electromotive system.

FIGS. 3a, 3b and 3c are diagrams illustrating the descent UAV 102 of FIG. 1 and sections thereof, according to embodiments of the invention. This exemplary embodiment has been designed to carry a payload of 3 kg and accommodate a 1-3U cubesat in the payload fairing 306.

The propulsive system 304 is in this example a series of EDFs 304 configured in a hex array of six modules, as shown in FIG. 3b, around the housing, which encloses the cylindrical payload volume 312. The propulsive system being electrically actuated also has the advantage of simplifying the energy storage and thrust control considerations. Each EDF as shown in FIG. 3c comprises a duct housing 314, and a series of rotor blades or fins 316. The schematic of FIG. 3c is simplified, for ease of reference; a typical ducted fan will have more blades per fan.

From an aerodynamic perspective, the vehicle 102 body in this and other embodiments is designed to minimise its drag when in simulation mode, whilst accommodating for example the propulsive system, power supply, communications system, data handling system, airbrake system 310 and the payload. As a result in this embodiment, all the aforementioned features are internally mounted except the propulsive system, which is of minimal cross-sectional area. Furthermore, both ends 308 of the descent vehicle will be tipped with nosecones shaped for optimal performance across the expected velocities of the test range. All external surfaces of the body are shaped and surface-finished to incur the minimum possible form and skin friction drag, respectively. Aerodynamic fins 313 are placed at the back of the vehicle to retain a high aerodynamic centre to ensure aerodynamic stability during the powered descent phase.

Three airbrake ‘petals’ 310 are formed by cut-outs from the outer tube, which are hinged in plane with the EDF housing module in order to keep the aerodynamic centre of the vehicle above the centre of mass upon airbrake deployment. The petals are configured to increase the flow-incident area of the vehicle and to increase the drag coefficient to achieve a terminal velocity below a threshold speed in free fall, which will enable the parachute deployment altitude to be kept below a threshold altitude for the minimisation of downrange drift. Once the altimeter detects the vehicle passing beneath the airbrake deployment altitude, the control system deactivates solenoid locks which hold the airbrake surfaces to the main body.

The airbrake surfaces are spring-loaded, so passively deploy once the currents through the solenoids are removed. Across the range of expected descent rates, the dynamically stable state of the system tends to the open case owing to the force of air resistance. This means that the hinge of the surfaces can be unpowered. Upon reaching the fully open configuration, the vehicle will experience a considerable drag force, acting primarily at the hinge of the deployment system. In order to ensure the descent vehicle is capable of performing repeated test and deceleration cycles, the magnitude of the shear force experienced at the hinges is reduced by adding pre-tension wires to create a secondary force propagation route.

The EDFs, aerodynamic fins, roll control surfaces and airbrake ‘petals’ are arranged with rotational symmetry around the central axis. The power supply, since it is one of the heavier components, is stored at the nose of the vehicle to lower the centre of mass as much as possible. Lowering of the centre of mass is also aided by the nosecone 308 material selection of silicon, which will also absorb impact energy upon landing to reduce the experienced deceleration levels in the payload bay.

Another element of the UAV system of embodiments of the invention is control of drag/deceleration in addition to descent acceleration, to not only provide micro-gravity simulation (a g reading as close to zero as possible) but also partial gravity, for example exactly 1.62 ms/s acceleration to simulate Lunar gravity, or 3.71 ms/s acceleration to simulate Martian gravity. To generate accurately controlled partial gravity can be a more complex problem than creating micro-gravity due to the fact that descent speed and acceleration must be kept lower than in the microgravity case, in such a way that the payload cannot be in freefall and must be retarded either by a variable drag force or by a variable reverse thrust force in order to maintain the desired acceleration level.

In one embodiment this can be achieved by using the same propulsion system as in the above embodiments, with one or more of the thrust means (e.g. EDFs) reversed into a lift orientation, thus providing a variable thrust component in the direction opposing descent. In an alternative, a thrust means that is reversible can be used for the descent UAV, so that the thrust means (or one or more thrust units of a thrust system) can be driven in an opposite mode or reversed during flight in order to provide the opposing direction thrust in addition to the downward thrust. However, in some circumstances this (and similar embodiments, and indeed previously considered systems attempting to use the same means to power lift or ascent as well as descent) may be hampered because if descending vertically the UAV is flying through its own efflux, so that the rotors/blades are operating inside the disturbed air they have already expelled downwards. This can limit the UAV's descent speed and/or limit the duration of partial gravity achieved before the vehicle exceeds operational limits.

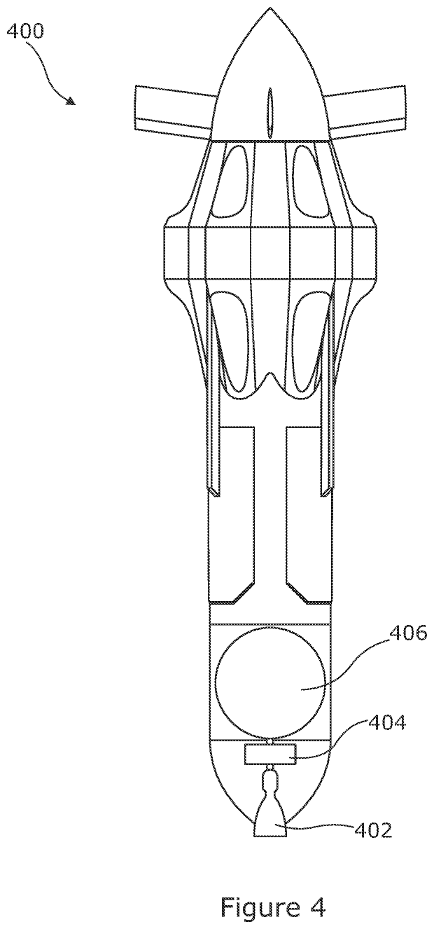

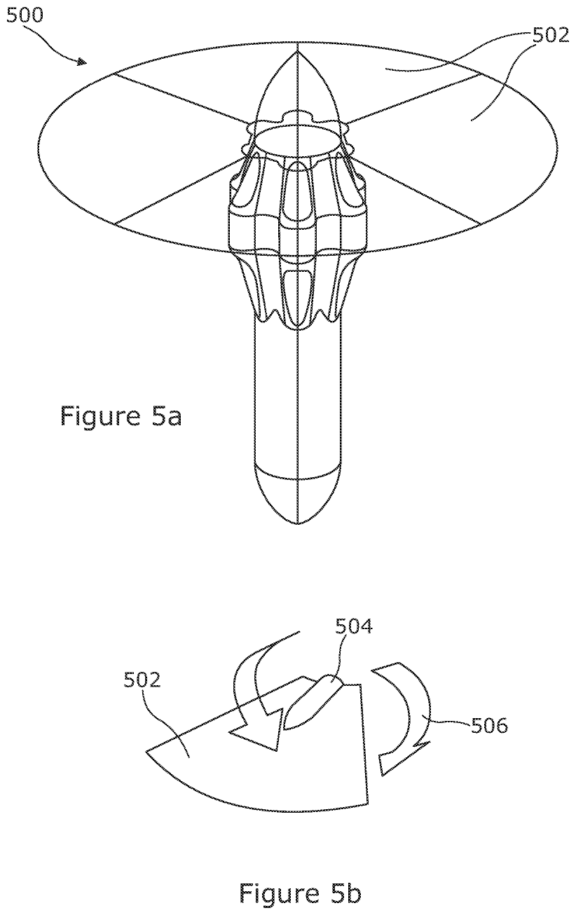

For alternative embodiments, FIGS. 4, 5a, 5b and 5c are diagrams illustrating a descent UAV having a descent thrust mitigation means, according to embodiments of the invention.

Whilst the objective for micro-gravity is to reduce the coefficient of drag of the descent vehicle or vehicle as much as possible, and countering any remaining drag effects with the downward facing EDF propulsion units to achieve a constant 9.8 m/s/s acceleration, the target for partial gravity may be an acceleration of 4 m/s/s to 6 m/s/s, meaning the vehicle needs to be actively slowed. Because drag increase is squared with velocity, simply making the vehicle more high drag will not buy much more duration unless an enormous amount more power can be put into the downward facing thrust means to counter that increasing drag effect by the same squared rate. In embodiments a variable inverse force is instead used for the downward facing thrust means to act against.

Each of the embodiments illustrated comprises a descent thrust mitigation means, operable to counteract the descent thrust. FIG. 4 shows a UAV 400 comprising a secondary thrust means, in this case a variable inverse thrust system, having a thrust chamber and nozzle 402, a propellant valve 404 and a propellant tank 406. In embodiments, the secondary thrust means can be a reaction-based propulsion system, such as a hot or cold gas thruster system or a monopropellant rocket motor that can provide a variable level of reverse thrust, mounted in the nose of the vehicle. This thruster can provide thrust up to a level of around 90% of the mass of the vehicle and can be throttled to counter some of the downward acceleration of the pod as it falls. This reverse force would be slightly higher than the amount needed to achieve the desired level of partial gravity on its own, with the descent thrust means (e.g. EDFs) still thrusting downwards in opposition to the thruster. This combination of the thrust mitigation means with the descent thrust means (such as EDFs) can preserve or provide the fine-control of the acceleration level during the powered descent.

This system sees the addition of the reverse-thruster system and its propellant tank mounted in a new module on the nose of the vehicle with the exit plane of the thruster nozzle exiting through the center of the nose cone.

The thruster can utilise a monopropellant such as hydrogen peroxide or decomposed nitrous oxide, or can be a cold-gas thruster using a gas like CO2 or pressure fed water or steam. Thrust of the system can be determined by the variable valve 404 that controls the flow of propellant to the chamber/catalyst, or by varying the pressure into the propellant tank 406 to vary the flow rate.

FIG. 5 illustrates a UAV 500 with one method of variable drag inducement, using variable-geometry drag-inducing panels 502 on the vehicle or pod to vary the drag coefficient of the pod as it falls. This is accomplished with a large ‘disk’ of rigid flat material mounted perpendicular to the longitudinal axis of the pod around the tail in place of the fins that would be there to maintain aerodynamic stability in the micro-gravity or thruster versions. This disk is segmented into panels, each of which can be rotated by 90 degrees, as shown 506 in FIG. 5b, via a rotational mounting 504. This allows the panel to move from presenting a flat side to the oncoming airflow to presenting its thin edge to the oncoming airflow.

By rotating these panels the drag coefficient of the pod can be varied significantly during the descent. Again, as with the reverse thruster of FIG. 4 it is assumed that drag can be set at a higher level so that the EDFs/descent thrust can control the descent acceleration more finely by acting against the varying drag force. It may be necessary to alternate an even number of panels around the pod, rotating them clockwise and anticlockwise in turn in order to avoid imparting a spin/roll to the descending pod and maintain aerodynamic symmetry.

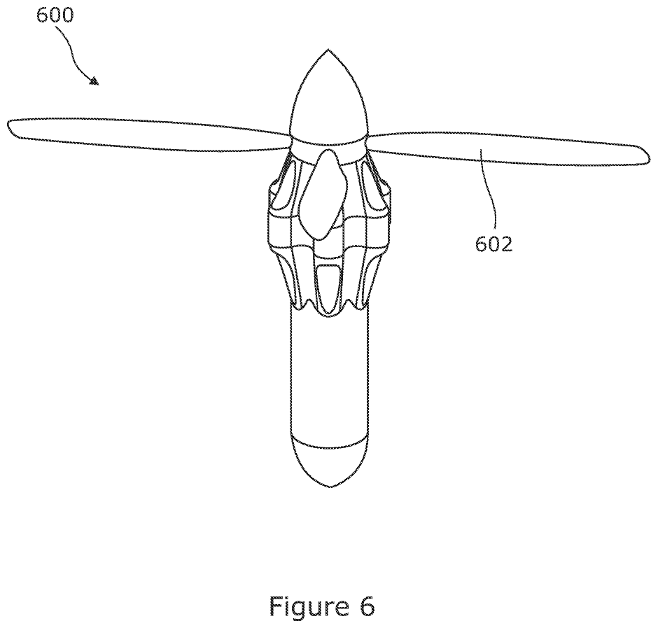

FIG. 6 illustrates an example UAV 600 using auto-rotating (unpowered) rotors 602 to provide the variable drag inducement or deceleration force upon the falling pod. This can induce controllable drag forces in opposition to the EDFs/descent thrust in similar fashion to the devices shown in FIG. 5. However, in one embodiment, the rotors can be controlled sufficiently to eliminate the need for the descent thrust means/EDFs altogether; in this case, there is no thrust means on the descent vehicle to simulate reduced gravity, only the drag inducement means. In other embodiments, devices such as those in FIGS. 4 and 5 can be used without descent thrust means in this manner.

This embodiment of FIG. 6 uses a variable braking system to control the speed that the rotors are allowed to spin at to control the drag/lift forces they create. This can also be augmented for finer control by adding the ability to control the pitch of the blades to increase or decrease their efficiency. The embodiment shown in FIG. 6 has a single set of rotors spinning in one direction; however, to reduce the inclination for the whole vehicle to spin and to aid control of the drag forces, it may be preferable to utilise two sets of counter-rotating blades.

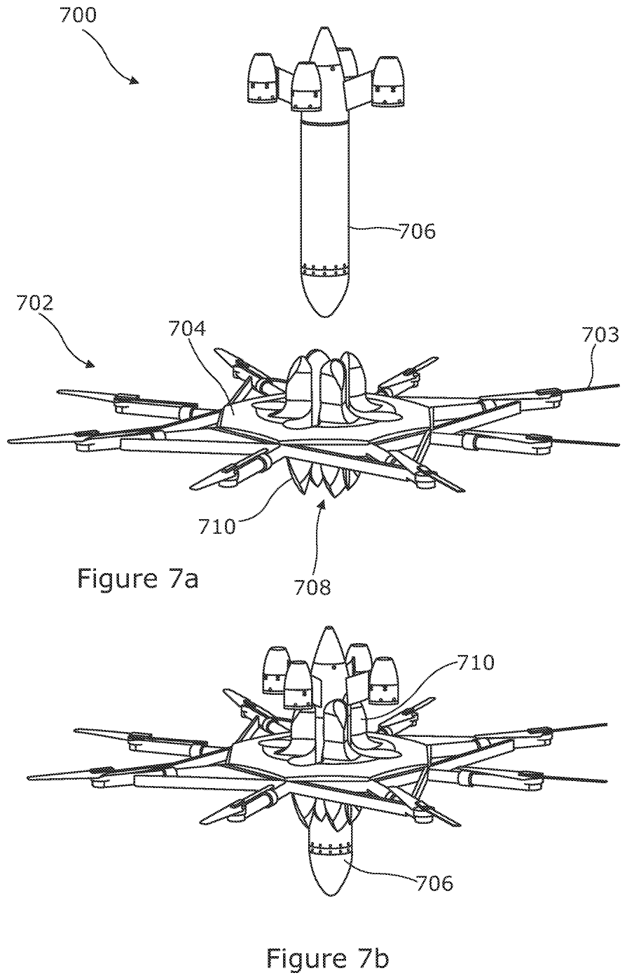

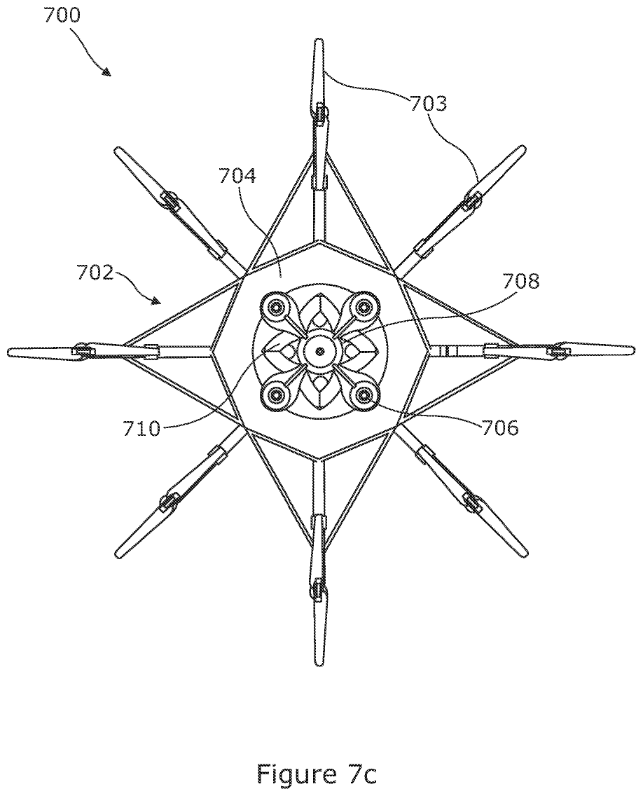

FIGS. 7a to 7c are diagrams illustrating components of a UAV system 700, according to an embodiment of the invention, in which the ascent UAV 702 having rotors 703 has an annular region or shape 704, to accommodate the descent UAV 706 within its bore 708. The ascent UAV may have a clasp means 710 for securing the descent UAV during transit, and for releasing it for the drop.

In embodiments, the clasp means comprises an electromagnetic clasp. In embodiments this when actuated grips the descent UAV along its circumference through the surface using power provided by the ascent vehicle bus. The attachment interface can be seen as the raised profiles 710 around the centre of the ascent UAV.

This arrangement has advantages such as being a fast, reliable and simple actuation mechanism, easily triggered by an electronic control system and without any moving parts. It also allows the ability to have a strong (and easily oversizeable) clasp without affecting the aerodynamics of either, but especially the descent, UAV. In addition it allows the ability to easily set the vertical positioning of the drop vehicle prior to launch, so that the common centre of mass position can be optimised, which promotes flight stability. In this way, the centre of mass position of the ascent UAV does not change (from the combined state) when the descent UAV is deployed, which allows the system to be better controlled as, for instance, it can use the same proportionality of flight controller (PID) tuning values before and after deployment.

Further, the aerodynamic stability of the vehicle as a combined system may be improved as the descent UAV is not underslung, as in other embodiments. The large surface interface is also an advantage for some deployment mechanisms.

Moreover, this arrangement allows a parachute system of the descent UAV to be used in the event of flight abort of the combined system prior to deployment. This adds another layer of failure redundancy to the system. In embodiments, both vehicles have a parachute system, but in those embodiments without an annular design of the ascent vehicle, only the parachute on the ascent vehicle can be used to recover the whole system in the event of loss of control prior to separation.

Furthermore, this arrangement reduces overall mass of the system, and allows for simplified design of the landing gear for the ascent vehicle, since the conveying means is no longer underneath the vehicle.

An isolated secondary power supply can provide a layer of redundancy should primary power fail and deactivate the clasp.

It will be appreciated by those skilled in the art that the invention has been described by way of example only, and that a variety of alternative approaches may be adopted without departing from the scope of the invention.

1. A UAV system for simulation of reduced-gravity environments, comprising:
an ascent UAV, comprising ascent thrust means; and
an aerodynamic, free fall descent UAV, comprising descent thrust means,
wherein the ascent UAV comprises means to convey the descent UAV to a drop altitude,
and wherein the descent UAV is separable from the ascent UAV,
the descent thrust means operable, following separation of the descent UAV from the ascent UAV, to provide a thrust component in a descent direction, for countering air resistance on the UAV.

2. A system according to any preceding claim, wherein the descent thrust means is operable to provide variable thrust.

3. A system according to claim 1 or claim 2, wherein the descent thrust means comprises a plurality of component thrust means.

4. A system according to any preceding claim, wherein the descent thrust means comprises a ducted fan system.

5. A system according to claim 4 as dependent on claim 3, wherein the ducted fan system comprises a plurality of electric ducted fans.

6. A system according to any preceding claim, wherein the descent UAV comprises:
a sensor system; and
a controller,
the sensor system operable, during descent of the UAV, to determine values for parameters associated with the acceleration due to gravity of the UAV, and
the controller operable to use the determined parameter values to control the descent thrust means.

7. A system according to any preceding claim, wherein the descent UAV comprises a descent thrust mitigation means, operable during operation of the descent thrust means to counteract the descent thrust means.

8. A system according to claim 7, wherein the descent thrust mitigation means comprises a secondary thrust means, operable to provide a variable thrust component in a direction opposing the descent direction.

9. A system according to claim 7, wherein the descent thrust mitigation means comprises a variable drag inducement means.

10. A system according to claim 9, wherein the variable drag inducement means is a modular component removable from the descent UAV.

11. A system according to claim 9 or claim 10, wherein the variable drag inducement means comprises at least one auto-rotating rotor.

12. A system according to claim 9 or claim 10, wherein the variable drag inducement means comprises at least one movable drag surface.

13. A system according to any preceding claim, wherein the descent UAV comprises a housing, which housing enclosing a payload volume.

14. A system according to claim 13, wherein the housing is shaped aerodynamically to reduce drag during descent of the descent UAV.

15. A system according to any preceding claim, wherein the descent UAV comprises at least one deployable passive deceleration means.

16. A system according to claim 15, wherein the at least one deployable passive deceleration means comprises at least one parachute.

17. A system according to claim 15, wherein the at least one deployable passive deceleration means comprises at least one deployable air brake device.

18. A system according to any of the claims 15 to 17, wherein the at least one deployable passive deceleration means comprises a first deployable passive deceleration means, and a second deployable passive deceleration means, wherein the second deployable passive deceleration means is operable after deploying the first deployable passive deceleration means.

19. A system according to any preceding claim, wherein the ascent UAV comprises a central annular region, and wherein the means to convey comprises means for accommodating the descent UAV within a bore of the ascent UAV annular region.

20. A UAV system for simulation of reduced-gravity environments, comprising:
a sensor system;
a controller; and
a ducted fan system,
the sensor system operable, during descent of the UAV, to determine values for parameters associated with the acceleration due to gravity of the UAV,
the controller operable to use the determined parameter values to control the ducted fan system, and
the ducted fan system operable, during descent of the UAV, to provide a thrust component in a descent direction, for countering air resistance on the UAV.

21. A UAV system according to claim 20, wherein the system comprises an ascent vehicle comprising ascent thrust means, and wherein a descent UAV comprises the sensor system, controller and ducted fan system.

22. A UAV system according to claim 21, wherein the ascent vehicle is operable to convey the descent UAV to a drop altitude, and wherein the descent UAV is separable from the ascent vehicle.

23. A method for simulation of reduced-gravity environments, comprising:
using an ascent UAV to convey an aerodynamic, free fall descent UAV to a drop altitude;
separating the descent UAV from the ascent UAV; and
following separation of the descent UAV from the ascent UAV, using a descent thrust means of the descent UAV to provide a thrust component in a descent direction, for countering air resistance on the descent UAV.
